(19) United States
(12) Patent Application Publication
(10) Pub. No.: US 2005/0132268 A1
(43) Pub. Date: Jun. 16, 2005

(54) Computer-based creation of a document in a markup language

(76) Inventor: Matthias Kammerer, Karlsruhe (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/470,051

(22) PCT Filed: Dec. 3, 2002
(86) PCT No.: PCT/EP02/13633

(30) Foreign Application Priority Data
Jan. 18, 2002 (DE) 02075233.3

(51) Int. Cl. G06F 17/00

(52) U.S. Cl. 715/513; 715/509; 715/505

(57) ABSTRACT

A document in a markup language containing text elements between first markers and second markers is created by: loading a master table containing formatting for a plurality of columns, the columns including a left-hand column containing the first markers, a right-hand column containing the second markers, and a central column; displaying the master table, receiving a user input in the central column; and removing the formatting while retaining the markers and the user input.

### FIELD OF THE INVENTION

The present invention relates to computer-based data processing in general, and also to methods, masters and programs for creating documents in particular.

### BACKGROUND

Markup languages are used in computer documents, for example to store and transmit data or to control Internet browsers.

The languages are known by abbreviations such as XML (Extensible Markup Language), HTML (Hypertext Markup Language), XHTML (Extensible Hypertext Markup Language), WML (Wireless Application Markup Language), or SGML (Standard Generalized Markup Language). The markers are instructions which are inserted (tags) into the documents, optionally with attributes.

In a document, syntax agreements contrast the markers with the contents. Normally, content (e.g. the word “example”) is situated between a start tag (e.g. <A>) and an end tag (e.g. </A>):
<A> example </A> (1)

Attributes are often situated within a tag, for example the “language” attribute in the expression “German” in the start tag in the following form:
<A LANGUAGE=“DE”> (2)

The markers are stipulated in document type definitions (DTD) and standards.

The documents are often used as interfaces between user and computer. They are created manually and processed by machine, are created and processed by machine, more rarely are created by machine and processed manually, or are created and processed manually. The first case is particularly critical, since the user requires knowledge of the markup language and at times errors are introduced which often remain unidentified. The user obtains technical support from computers with programs such as editors and parsers. Special editors assist the user in creation. Parsers check the finished documents.

However, technical problems remain:
(a) Special editors and parsers require the respectively valid definitions. The definitions are often managed separately from the document, which means that the wrong definition is used in the error situation.
(b) Suitable editors and parsers are often not available.
(c) Editors and parsers are special programs whose use is the reserve of experts.

### SUMMARY

The problems are solved using an inventive method in accordance with the main claim. A computer program product (CPP) and preferred embodiments are the subject matter of the further claims.

A master format is provided which already contains the most important markers. The user merely inputs the content between the markers and prompts the computer for automatic conversion to the finished document.

Specifically, the invention relates to a computer-based method for creating a document in a markup language. The document contains text elements which are respectively situated between first markers (e.g. start marker) and second markers (e.g. end marker). The method contains the following method steps:
loading of a master table containing formatting for a first column containing the first markers, for a second column containing the second markers, and for a third column (situated between the first and second columns);
display of the master table;
reception of a user input in the third column;
removal of the formatting while retaining the markers and the user input.

Preferably, the markup languages are XML, HTML, XHTML and SGML. In this case, the first markers are start tags and the second markers are end tags. The markers can also encompass attributes. Optionally, a comment identifier is loaded which indicates the meaning of the user input to the user. Optionally, loading involves hiding the markers, which means that display is restricted to the third column. Optionally, write protection is introduced for the first and second columns. Form functions, advice and help are likewise optional.

The following properties are also optional: during loading, the master table is in the form of a table in a word processing program. Display involves the table being displayed on a screen. Removal involves the table (a) being copied to a clipboard and from there being copied to a text editor, or (b) the table being stored in a text format.

The word processing program has the functionalities of the program WORD, and the text editor has the functionalities of the program NOTEPAD. Loading involves loading a master table whose third column is contained in form functions or brief help.

The invention also relates to a computer-based method for creating a master table for a document in a markup language, the document being intended to contain text elements which are respectively situated between start markers and end markers. The method is characterized by the creation of three table columns, where the central column can receive the text elements as user inputs and the formatting of the columns can be removed, and by the evaluation of a definition file (DTD) containing definitions for describing the left-hand column containing start markers and definitions for the right-hand column containing end markers, the start markers and the end markers being in a permanent form (i.e. not removable).

The invention also relates to a computer program product (CPP) as a master table for creating a document in a markup language. The columns are formatted as a first column containing first markers, as a second column containing second markers, and as a third column between the first and second columns for receiving a user input. The formatting is removable while retaining the markers and the user input, so that the document is available in the markup language when the formatting has been removed.

Preferably, the markers in the product are based on the language XML, the markers being determined by a DTD.

The method provides an advantageous solution to the problems cited above.
(a) Definitions and document are inseparably associated.
(b) The master table is capable of execution on commercially available word processing programs in widespread use and is not limited to a particular program.
(c) The user uses the word processing program to which he is accustomed. Comments and extended formatting (hidden text, forms, advice, help) provide the user with the necessary information, impose predetermined inputs (e.g. through form function), and prevent intentional falsification of the definitions (e.g. in the outer columns).

Accordingly the documents correspond to the definition (“valid” documents). The user requires no programming knowledge and no knowledge of the markup language. Write protection prevents incorrect input.

The master itself can be sold in a markup language and can be interpreted by the word processing program.

### BRIEF DESCRIPTION OF THE DRAWINGS

FIG. 1 shows a general computer system;

FIG. 2 shows a document in a markup language with markers in the form of start tags and end tags;

FIG. 3 shows a master table in accordance with the invention;

FIG. 4 shows a flowchart for a method in line with the invention;

FIG. 5 shows a document with comments;

FIG. 6 shows an extended master table;

FIG. 7 shows a document containing attributes;

FIG. 8 shows an extended master table.

### GENERAL COMPUTER SYSTEM

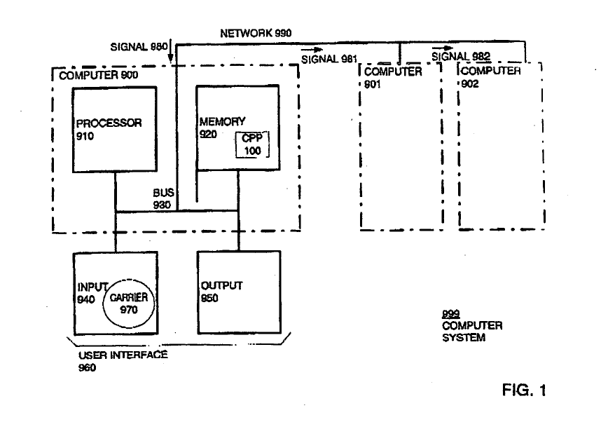

FIG. 1 shows a simplified block diagram of a computer network system 999 containing a multiplicity of computers (or 90q, q=0 . . . Q-1, Q arbitrary).

The computers 900-902 are connected via a network 990. The computer 900 comprises a processor 910, a memory 920, a bus 930 and, optionally, an input device 940 and an output device 950 (input device and output device produce the user interface 960). The invention is in the form of a computer program product (CPP) 100 (or 10q, where q=0 . . . Q-1, Q arbitrary), in the form of a program carrier 970 and in the form of a program signal 980. These components are referred to below as program. The elements 100 and 910-980 of the computer 900 collectively illustrate the corresponding elements 10q and 91q-98q (shown for q=0 in the computer 90q).

Computer 900 is, by way of example, a conventional personal computer (PC), a multiprocessor computer, a mainframe computer, a portable or fixed PC or the like.

The processor 910 is, by way of example, a central processor (CPU), a microcontroller (MCU), or a digital signal processor (DSP).

The memory 920 symbolizes elements which store data and instructions either temporarily or permanently. Although the memory 920 is shown as part of the computer 900 to assist understanding, the memory function can also be implemented at another point in the network 990, for example in the computers 901/902 or in the processor 910 itself (e.g. cache, register) The memory 920 can be a read only memory (ROM), a random access memory (RAM) or a memory having other access options. The memory 920 is physically implemented on a computer-readable data carrier, for example on: (a) a magnetic data carrier (hard disk, diskette, magnetic tape); (b) an optical data carrier (CD-ROM, DVD); c) a semiconductor data carrier (DRAM, SRAM, EPROM, EEPROM); or on any other medium (e.g. paper).

Optionally, the memory 920 is distributed over various media. Parts of the memory 920 can be fitted on a permanent or replaceable basis. For the purposes of reading and writing, the computer 900 uses known means such as disk drives or tape drives.

The memory 920 stores support components, such as a Bios (Basic Input Output System), an operating system (OS), a program library, a compiler, an interpreter or a word processing program. Support components are commercially available and can be installed on the computer 900 by persons skilled in the art. To assist understanding, these components are not shown.

CPP 100 comprises program instructions and, optionally, data which prompt the processor 910, inter alia, to execute the method steps 430-450 in the present invention. The method steps are explained later in detail. In other words, the computer program 100 defines the operation of the computer 900 and its interaction with the network system 999. Without intending any restriction in this context, CPP 100 can, by way of example, be in the form of source code in any desired programming language and in the form of binary code in compiled form. A person skilled in the art is capable of using CPP 100 in connection with any of the support components explained above (e.g. compiler, interpreter, operating system).

Although CPP 100 is shown as being stored in the memory 920, CPP 100 can alternatively be stored at any other point. CPP 100 can likewise be stored on the data carrier 970.

The data carrier 970 is shown outside the computer 900. To transfer CPP 100 to the computer 900, the data carrier 970 can be introduced into the input unit 940. The data carrier 970 is implemented in the form of any desired, computer-readable data carrier, such as in the form of one of the carriers explained above (cf. memory 920). Generally, the data carrier 970 is a product which contains a computer-readable medium storing computer-readable program code means which are used to execute the method of the present invention. In addition, the program signal 980 can likewise comprise CPP 100. The signal 980 is transferred to the computer 900 via the network 990.

The detailed description of CPP 100, carrier 970 and signal 980 can be applied to the data carriers 971/972 (not shown), to the program signal 981/982, and to the computer program product (CPP) 101/102 (not shown), which is executed by the processor 911/912 (not shown) in the computer 901/902.

The input device 940 represents a device which provides data and instructions for processing by the computer 900. By way of example, the input device 940 is a keyboard, a pointer device (mouse, trackball, cursor arrows), a microphone, a joystick, a scanner. Although the examples are all devices with human interaction, the device 940 can also operate without human interaction, such as a wireless receiver (e.g. using a satellite antenna or terrestrial antenna), a sensor (e.g. a thermometer), a counter (e.g. a quantity counter in a factory). Input device 940 can likewise be used for reading the data carrier 970.

The output device 950 represents a device which displays instructions and data which have already been processed. Examples thereof are a monitor or other display (cathode ray tube, flat screen, liquid crystal display, loudspeaker, printer, vibration alarm). In a similar manner to the case of the input device 940, the output device 950 communicates with the user, but it can likewise communicate with other computers.

The input device 940 and the output device 950 can be combined in a single device. Both devices 940, 950 can be provided optionally.

The bus 930 and the network 990 represent logical and physical connections which transfer both instructions and data signals. Connections within the computer 900 are usually referred to as bus 930, connections between the computers 900-902 are referred to as network 990. The devices 940 and 950 are connected to the computer 900 by the bus 930 (as shown) or—optionally—via the network 990. The signals within the computer 900 are predominantly electrical signals, whereas the signals in the network can be electrical, magnetic and optical signals or else wireless radio signals.

Network environments (such as network 990) are normal in offices, company-wide computer networks, intranets and on the Internet (i.e. world wide web). The physical distance between the computers in the network is of no significance. Network 990 can be a wireless network or a wired network. Possible examples of implementations of the network 990 which may be mentioned here are as follows: a local area network (LAN), a wide area network (WAN), an ISDN network, an infrared link (IR), a radio link such as the Universal Mobile Telecommunication System (UMTS), or a satellite link.

Transfer protocols and data formats are known. Examples thereof are: TCP/IP (Transmission Control Protocol/Internet Protocol), HTTP (Hypertext Transfer Protocol), URL (Unique Resource Locator), HTML (Hypertext Markup Language), XML (Extensible Markup Language), WML (Wireless Application Markup Language), etc.

Interfaces for coupling the individual components are likewise known. To simplify matters, the interfaces are not shown. An interface can be, by way of example, a serial interface, a parallel interface, a game port, a universal serial bus (USB), an internal or external modem, a graphics adapter or a sound card.

Computer and program are closely related. In the description, expressions such as “the computer provides” and “the program provides” are normal abbreviations which describe program-controlled method steps in the computer.

### DETAILED DESCRIPTION OF THE OTHER DRAWINGS

Three-digit reference numerals appear above the denoted elements or to the left thereof. They are neither part of the master table nor of the document, however. Spaces and gaps between the characters shown serve only to assist understanding and can be dropped.

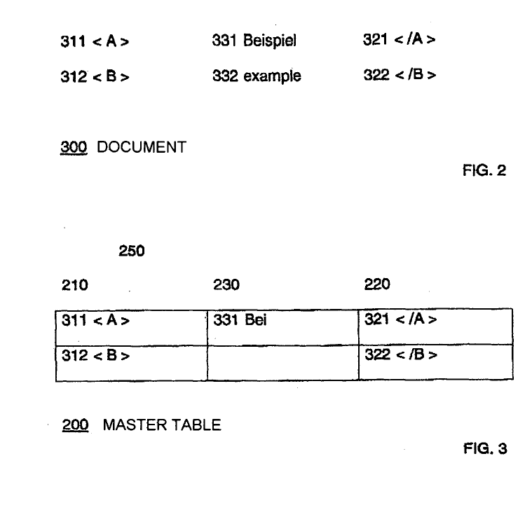

FIG. 2 shows a document 300 in a markup language, which has been created on the basis of method 400 in line with the present invention.

The simplified illustration of document 300 is representative of the input 331, 332
“Beispiel”=“example” (3)
into a German-English dictionary. The meaning of the markers A and B is predetermined, for example in a definition (Document Type Definition, DTD). The markers as start tags 311, 312 and end tags 321, 322 are shown in XML.

FIG. 3 shows the inventive master table 200. Tags 311, 312, 321, 322 and input 331, 332 correspond to those in the document 200 in FIG. 2. The user is currently writing the word “Beispiel” for the input 331.

The master table 200 has the following formatting 250: left-hand column 210 (containing markers 311, 312), right-hand column 220 (markers 321, 322), and central column 230 (for input 331, 332).

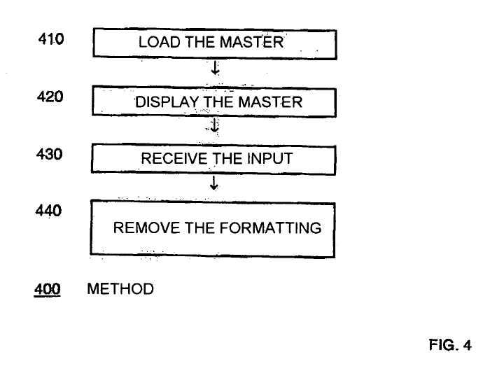

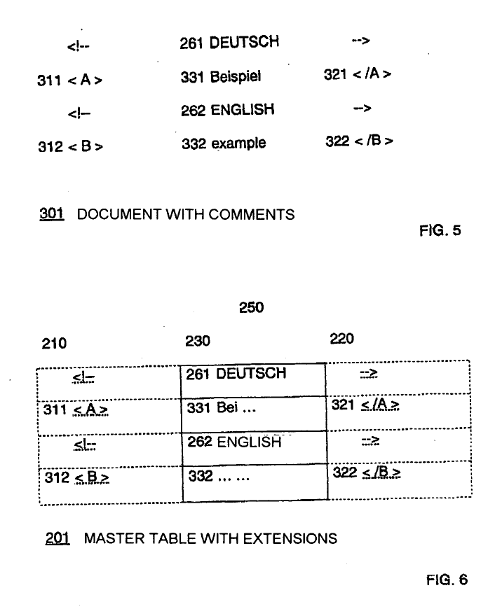

FIG. 4 shows a flowchart for a method 400 having the following method steps:
Loading 410 of a master table 200 (cf. 201, 202 in FIGS. 6, 8) having the formatting 250 for the first column 210 containing the first markers 311, 312, for the second column 220 containing the second markers 321, 322, and for the third column 230 between the first and second columns 210, 220, cf. FIG. 3;
Display 420 of the master table 200, cf. FIG. 3;
Reception 430 of a user input 331, 332 in the third column 230, cf. FIG. 3;
Removal 440 of the formatting 250 while retaining the markers 311, 312, 321, 322 and the user input 331, 332, cf. FIG. 2.

FIGS. 5-8 show further embodiments with the document and the master table as an addition to FIGS. 2-3. The embodiments can also be combined. The documents 301, 302 are extensions of the document 300; similarly, the master tables 201, 202 are extensions of the master 200.

FIG. 5 shows a document 301 with comments. The comments 261, 262 (“GERMAN”, “ENGLISH”) are held within the comment markers (<!—and →) in additional rows. A parser will ignore the comments during processing. The parser can also remove the comments from document 301, however, for example in order to reduce the data volume. To this end, the parser is given an appropriate instruction (e.g. Extensible Style Language—XSL).

FIG. 6 shows an extended master table 201 having extended formatting (e.g. hidden text, forms, advice, help) which can be set using commercially available word processing programs.

Hidden text applies to the comment markers (<!—and →>) and to the markers 311, 312 (left) and 321, 322 (right). Hidden text is represented by dotted lines. The user sees only the comments (“German” and “English”), which remain visible all the time. Hidden text optionally also applies to the borders for the columns 210 and 220 (dashed lines).

Form functions are indicated in column 230 by ellipses ( . . . ). By way of example, the formats of the user input 331, 332 are stipulated. The user is compelled to use only predetermined characters for input, for example: only numbers (with or without decimal points), only letters, lower-case or upper-case letters, words of a maximum length, etc.

Advice is displayed when, by way of example, the user puts the mouse into the first row of the table. Possible advice for master 201 is, by way of example: “Please enter the words in full.”

Help can be displayed when the user activates, by way of example, the function key “F1” or a corresponding menu item.

Write protection (not shown) can be arranged for the outer columns 210, 220, for example.

In the last method step 440, removal of the formatting —to finish the document—the hidden text disappears (markers become visible). The user inputs remain unchanged. Advice, help and write protection are no longer necessary.

In other words, the extended formatting of the word processing program is used only while the user is working with the program.

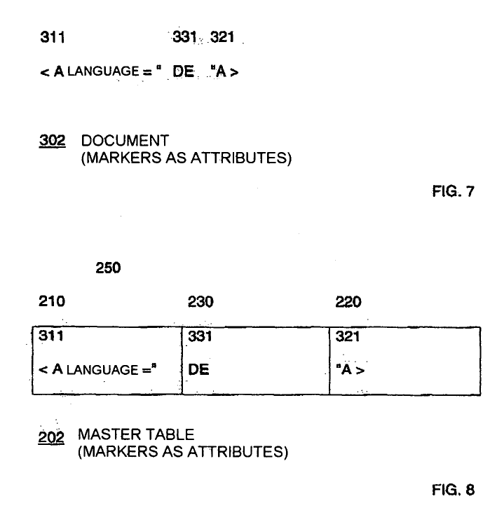

FIG. 7 shows a document 302 with attribute markers. For the markers <A> 311, 321, the user has set the LANGUAGE attribute to the value DE 331:
<A LANGUAGE=“DE”> (4)

FIG. 8 shows the extended master table 202 as the basis for the document 302. The start marker 311 (left-hand column 210) contains the start tag with the name of the attribute; the user input 331 (central column 230) is the DE stipulation; and the end marker 321 (right-hand column 220) contains the end tag.

Whereas, in the example in FIGS. 7-8, the user stipulates the LANGUAGE attribute, in the example below the attribute is fixed at the value DE. The user is asked to input the content (e.g. the word “Patentanmeldung”) of the attributed tag.

The document reads:
<A LANGUAGE=“DE”>Patentanmeldung </A> (5)

The master format reads:
311 <A LANGUAGE “DE”> (6)
321 </A> (7)

The present invention has been explained using the preferred embodiment of the master table 200, 201, 203 with 3 columns. A person skilled in the art can add columns for markers and inputs. By way of example, the user inputs both the attribute (LANGUAGE) and the content, i.e. for the following document:
<A LANGUAGE “DE”>Anspruch </A> (8)
<A LANGUAGE “EN”>claim </A> (9)

Other examples of documents in markup languages are
dictionaries,
patent applications (tag <A> for the title, <B> for the description, <C No.=“ ”> for the claims with numbers, etc.),
documentation for software, hardware, etc.,
operating instructions (advantageous for multilingual documents),
text with marginal notes (e.g. legal comments).

The type of text—whether dictionary or documentation—is insignificant. The markers allow the document 300 to be converted to other forms, for example to a printable file (WORD formats such as *.doc or *rtf; PDF file), to a paper print, to an Internet presentation (HTML). Conversion can be done by a person skilled in the art, for example using other masters (e.g. style sheet) and language transformations (e.g. Extensible Style Language Transformation—XSLT), without requiring further explanations at this point.

In other words, the invention is also advantageous for creating other documents (e.g. dictionaries) which are derived from documents in a markup language.

Commercially available word processing programs are, by way of example, the programs WORD and NOTEPAD (Microsoft), StarOffice (Sun) and WordPerfect (Corel) Spreadsheet programs can also be used.

Reference Numerals

100 computer program product
200, 201, 202 master table
210 first column (left)
220 second column (right)
230 third column (center)
250 formatting
261, 262 comment
300, 301, 302 document
311, 312 first marker (start)
321, 322 second marker (end)
331, 332 user input
400 method
410 loading
420 display
430 reception
440 removal
9xx computer with components

1. A computer-based method for creating a document in a markup language, the document containing text elements which are respectively situated between first markers and second markers, the method comprising:
loading of a master table containing formatting for a plurality of columns, wherein the plurality of columns comprise:
a first column containing the first markers;
a second column containing the second markers; and
a third column, situated between the first and second columns;
displaying the master table;
receiving a user input in the third column; and
removing the formatting while retaining the markers and the user input.

2. The method according to claim 1, wherein the markup language is XML, HTML or SGML and the first markers are start tags and the second markers are end tags.

3. The method according to claim 1, wherein the markup language is XML, HTML, XHTML or SGML and the first markers and the second markers encompass attributes.

4. The method according to claim 1, wherein loading includes loading a comment, the comment indicating the meaning of the user input to the user.

5. The method according to claim 1, wherein loading comprises hiding the markers so that displaying is limited to the third column.

6. The method according to claim 1, further comprising introducing a write protection for the first and second columns.

7. The method according to claim 1 wherein
loading step, loading the master table is in the form of a table in a word processing program;
displaying the table is occurs on a screen; and
removing comprises copying the table to a clipboard and subsequently copying the table to a text editor, or storing the table in a text-only format.

8. The method according to claim 7, wherein the word processing program includes the functionalities of the program WORD and the text editor includes the functionalities of the program NOTEPAD.

9. The method according to claim 7, wherein the third column comprises form functions or brief help.

10. A computer-based method for creating a master table for a document in a markup language, the document containing text elements which are respectively situated between start markers and end markers, the method comprising:
creating three table columns that include at least one of the following properties:
a central column that can receive user inputs;
the ability to remove formatting of the columns; and evaluating a definition file containing definitions for describing a left-hand column using start markers and definitions for a right-hand column containing end markers, the start markers and the end markers being in a permanent form.

11. A computer program product including a master table for creating a document in a markup language an including column formatting the column formatting comprising:
a first column containing first markers;
second column containing second markers; and
a third column between the first and second columns for receiving a user input;
wherein the column formatting is removable while retaining the markers and the user input, so that the document is available when the formatting has been removed.

12. The computer program product according to claim 11, wherein the markers are based on the language XML, with the markers being made available by converting a definition file.
